(19) United States
(12) Patent Application Publication
(10) Pub. No.: US 2017/0187057 A1
(43) Pub. Date: Jun. 29, 2017

(54) HYDROGEN GENERATOR AND FUEL CELL SYSTEM AND METHOD

(71) Applicant: ARIZONA SCIENCE AND TECHNOLOGY ENTERPRISES, LLC, Scottsdale, AZ (US)

(72) Inventor: JEKANTHAN THANGAVELAUTHAM, TEMPE, AZ (US)

(73) Assignee: ARIZONA BOARD OF REGENT ON BEHALF OF ARIZONA STATE UNIVERSITY, SCOTTSDALE, AZ (US)

(21) Appl. No.: 15/129,168

(22) PCT Filed: Mar. 25, 2015
(86) PCT No.: PCT/US2015/022556

§ 371 Date: Sep. 26, 2016

(30) Foreign Application Priority Data
Mar. 25, 2014 (US) 61970230

(51) Int. Cl. H01M 8/065; H01M 8/04828; H01M 8/04291

(52) U.S. Cl. CPC H01M 8/065; H01M 8/04291; H01M 8/04843; H01M 8/04947; H01M 2250/20

(57) ABSTRACT

Embodiments of the invention provide a fuel cell system including a fuel cell coupled to a controller configured to route power generated by the fuel cell to at least one peripheral device. Embodiments include a hydrogen generator including a reactor vessel enclosed by a housing. The hydrogen generator is fluidly coupled to the fuel cell and configured to deliver hydrogen to the fuel cell. Embodiments include at least one water harvesting system fluidly coupled to the hydrogen generator and configured to deliver water or water vapor to the hydrogen generator using a controller. Some embodiments include at least one waste heat recovery system used to heat harvested water or water vapor delivered to the hydrogen generator. Some embodiments include a fuel cell system fueling method using the hydrogen generator fluidly coupled to the fuel cell including delivery of captured water or water vapor to the hydrogen generator.

### RELATED APPLICATIONS

This application claims priority from U.S. Patent Application No. 61/970,230, entitled “HYDROGEN GENERATOR AND FUEL CELL SYSTEM AND METHOD” filed on Mar. 25, 2014, the entire contents of which are incorporated herein by reference.

### BACKGROUND

Small mobile devices including unmanned aerial vehicles (“UAVs”) and other autonomous systems such as ground robots are emerging as important new tools with applications in military, civilian and commercial life. Small mobile robots operating for long durations have the potential to perform many important missions in field environments, such as post-disaster search and rescue, exploration, border patrol and sentry duty. Many of these missions require nearly continuous operation for long periods including days and weeks rather than hours.

Most commonly, mobile robots are powered by batteries. Some systems have also used internal combustion engines, and in a few cases (such as the Mars explorer vehicles) solar photovoltaic panels. Combustion engines have high power and high energy, but are noisy and produce toxic exhaust that can make them generally unsuitable for most applications. Solar panels are rarely used because of the large surface areas required, and variability in performance due to various environmental factors including dust and temperature. For these and other reasons, batteries have emerged as the power source of choice. However, weight and size constraints usually prevent current batteries from powering long range and/or long duration missions. In general, batteries are able to provide relatively high power for short periods, but the total energy they can provide is limited due to their size and chemistry. Even with steady advancements in battery technologies, numerous studies have concluded that batteries will not be able to meet the long duration field requirements of autonomous systems.

Fuel cells have been proposed for various robotic and field applications such as for powering unmanned underwater vehicles, humanoid robots, hopping robots, and other ground robotic systems. Fuel cells, including for example, proton-exchange membranes (PEM) fuel cells, have high operating efficiencies of 50-70%, and their chemistries (using hydrogen and oxygen for example) can in theory produce more sustained energy than the best batteries available today. Recent studies have shown that PEM fuel cells can survive long duration field missions if they are properly designed, and key operating variables are well controlled. These variables can include the temperature of the cells, the temperature and humidity of the hydrogen and air supplies, the operating voltage, and fluctuations in power demand and electronic noise reflected back to the fuel cell from attached electronics. The effects of the variations in the power demand can effectively be controlled by deploying a hybrid configuration that can prevent electrical noise (produced for example from a DC-DC converter) from adversely impacting the fuel cell system. However, despite their potential, one of the limiting factors in the use of PEM fuel cells for long-duration application is the source of hydrogen and hydrogen fuel storage. Storing hydrogen as a liquid at cryogenic temperatures or at very high pressures is not practical for relatively small devices. Storing hydrogen in a solid hydride form that releases hydrogen through depressurization has been considered; however the hydrogen storage efficiencies are very low (only 0.5% to 2.5% by weight of hydrogen). The use of metal hydrides through reaction with water to release hydrogen provides one promising alternative. However, water storage and delivery, and control of the reaction temperature can be helpful for enabling a reliable and efficient fuel delivery system.

### SUMMARY

Some embodiments of the invention provide a fuel cell system comprising a fuel cell coupled to at least one controller, where the at least one controller is configured to route power generated by the fuel cell to at least one peripheral device. The fuel cell system comprises a hydrogen generator comprising a reactor vessel at least partially enclosed by a reactor housing, where the hydrogen generator is fluidly coupled to the fuel cell and configured to deliver hydrogen to the fuel cell. The fuel cell system includes at least one water harvesting system coupled to the at least one controller, where the at least one water harvesting system fluidly coupled to the hydrogen generator and configured to deliver water or water vapor to the hydrogen generator.

In some embodiments, the hydrogen generator comprises a lithium hydride reactor. Some embodiments further comprise at least one auxiliary power source coupled to the at least one controller. In some embodiments, the at least one water harvesting system comprises a water scavenging module configured to extract water from ambient air. In some further embodiments, the at least one water harvesting system comprises fuel cell emitted water captured from the fuel cell.

In some embodiments of the invention, the hydrogen generator includes insulation positioned at least partially between the reactor housing and reactor vessel. Some embodiments further comprise at least one waste heat recovery system. In some embodiments, the waste heat recovery system comprises at least one insulated conduit within the hydrogen generator. In some further embodiments, the waste heat recovery system comprises at least one conduit coupled to the at least one peripheral device.

Some embodiments of the invention further comprise at least one control valve configured to control a flow of the water or water vapor to the hydrogen generator. In some embodiments, the at least one control valve comprises an electroactive bypass valve. In some other embodiments, the at least one control valve is configured and arranged to control flow of the water or water vapor from the fuel cell.

In some embodiments, the at least one controller is configured and arranged to control delivery of the water or water vapor to the reactor vessel to maintain a lithium hydrolysis reaction temperature of between about 70° C. and about 120° C.

Some embodiments of the invention include a fuel cell system comprising a fuel cell coupled to at least one controller, where the at least one controller configured to route power generated by the fuel cell to at least one peripheral device, and a hydrogen generator comprising a reactor vessel at least partially enclosed by a reactor housing, where the hydrogen generator includes a first waste heat recovery system comprising at least one insulated conduit within the hydrogen generator. The fuel cell system also includes a plurality of water capturing systems coupled to the at least one controller, where the plurality of water capturing systems include at least one water scavenging module configured to extract water from ambient air and at least one water harvesting system comprising fuel cell emitted water captured from the fuel cell. Further, the plurality of water capturing systems are fluidly coupled to the hydrogen generator and configured to deliver captured water or water vapor to the hydrogen generator. Further, the fuel cell system includes a second waste heat recovery system comprising at least one conduit coupled to the at least one peripheral device.

Some embodiments of the invention include a fuel cell system fueling method comprising providing a fuel cell coupled to at least one controller, where the at least one controller is configured to route power generated by the fuel cell to at least one peripheral device. The method further includes fluidly coupling a hydrogen generator to the fuel cell, where the hydrogen generator comprises a reactor vessel at least partially enclosed by a reactor housing. The method further includes fluidly coupling at least one water capturing system to the hydrogen generator, and producing a source of hydrogen by operating the at least one water capturing system to deliver water or water vapor to the hydrogen generator. The method further includes routing the hydrogen to the fuel cell to produce power, where the power is optionally used to power the at least one peripheral device.

In some embodiments of the method, the hydrogen generator includes a first waste heat recovery system comprising at least one insulated conduit within the hydrogen generator. In some further embodiments of the method, the at least one water capturing system includes at least one of a water scavenging module configured to extract water from ambient air and at least one water harvesting system comprising fuel cell emitted water captured from the fuel cell.

Some embodiments include a computer-implemented control method for operating a fuel cell system comprising a non-transitory computer-readable medium in data communication with at least one processor, where the non-transitory computer-readable medium includes software instructions comprising a fuel cell control system and method, and one or more processors configured to execute the software instructions. Execution of the instructions causes the method to instruct at least one controller to operate a fuel cell coupled to at least one controller, and operate at least one water capturing system to deliver water or water vapor to a hydrogen generator fluidly coupled to the fuel cell. Execution of the instructions also causes the method to control delivery of hydrogen from the hydrogen generator to the fuel cell to produce power, where the power is optionally used to power at least one peripheral device.

In some further embodiments of the computer-implemented control method, the at least one controller controls delivery of the water or water vapor to the reactor vessel to maintain a lithium hydrolysis reaction temperature of between about 70° C. and about 120° C.

### DESCRIPTION OF THE DRAWINGS

FIG. 1 is a schematic of a fuel cell system comprising a lithium hydride hydrogen generation system including a water scavenging module according to one embodiment of the invention.

FIG. 2 is a schematic of a fuel cell system comprising a lithium hydride hydrogen generation system including a fuel cell water delivery system according to one embodiment of the invention.

FIG. 3 is a schematic of a fuel cell system comprising a lithium hydride hydrogen generation system including a water scavenging module and a fuel cell water delivery system according to one embodiment of the invention.

FIG. 4 is a schematic of a fuel cell system comprising a lithium hydride hydrogen generation system including a water scavenging module and a waste heat capture system according to one embodiment of the invention.

FIG. 5 is a schematic of a fuel cell system comprising a lithium hydride hydrogen generation system including a fuel cell water delivery system and a waste heat capture system according to one embodiment of the invention.

FIG. 6 is a schematic of a fuel cell system comprising a lithium hydride hydrogen generation system including a fuel cell water delivery system, a waste heat capture system, and a water scavenging module according to one embodiment of the invention.

FIG. 7 is a schematic of a fuel cell system comprising a lithium hydride hydrogen generation system including a fuel cell water delivery system and a waste heat capture system according to another embodiment of the invention.

FIG. 8 is a schematic of a fuel cell system comprising a lithium hydride hydrogen generation system including a water scavenging module and a waste heat capture system according to another embodiment of the invention.

FIG. 9 is a schematic of a fuel cell system comprising a lithium hydride hydrogen generation system including a fuel cell water delivery system, a waste heat capture system, and a water scavenging module according to another embodiment of the invention.

FIG. 10 illustrates a computer system configured for operating and processing components and methods of operation of a fuel cell system in accordance with some embodiments of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Some embodiments of the invention can include a control system and method that can help to optimize the release of hydrogen from a lithium hydride hydrogen generator. Some embodiments of the invention can enable control of a thermally activated lithium hydride hydrogen generator. Further, any one of the embodiments of the invention as described herein can help an operator to optimize the performance of the system to improve the operational output and efficiency, particularly when coupled or integrated with one or more fuel cell systems. For instance, when combined with fuel cell systems comprising proton-exchange membranes (hereinafter referred to as “PEM”), any one of the embodiments of the invention as described herein can allow an operator to optimize the performance of the system for mobile electrical loads, providing an opportunity to achieve a very high energy, power and efficiency. For example, some embodiments of the invention described herein can offer the capability to achieve fuel energy densities of about 4,850 Wh/kg, with chemical to electrical conversion efficiencies of about 65% for the fuel cell. In some embodiments, this system can be used to power unmanned aerial vehicles, ground robots, sensor networks and space suits. In addition, the embodiments described herein can be implemented with other applications than can benefit from very high density hydrogen storage including short range rockets, missiles and attitude thrusters.

There are two types of metal hydrides for storage of hydrogen: chemically activated hydrides that release hydrogen through chemical reaction and non-chemically activated hydrides that trigger the release of hydrogen through changes in pressure or temperature. While non-chemically activated hydrides are valued because of their ability to be recharged with hydrogen, they are not ideal for long-life devices because they normally have low hydrogen densities (defined as the weight of the hydrogen divided by the total weight of the hydride) that are on the order of about 1-2%. Chemically activated hydrides normally have higher weight percent of hydrogen, and of these, lithium hydride has one of the highest hydrogen densities of about 12.5%. Alkali metal-based hydrides are quite reactive in the presence of water, resulting in a release of hydrogen upon contact. In some embodiments, the released hydrogen can be stored temporarily, or used directly as a source of fuel in a PEM fuel cell.

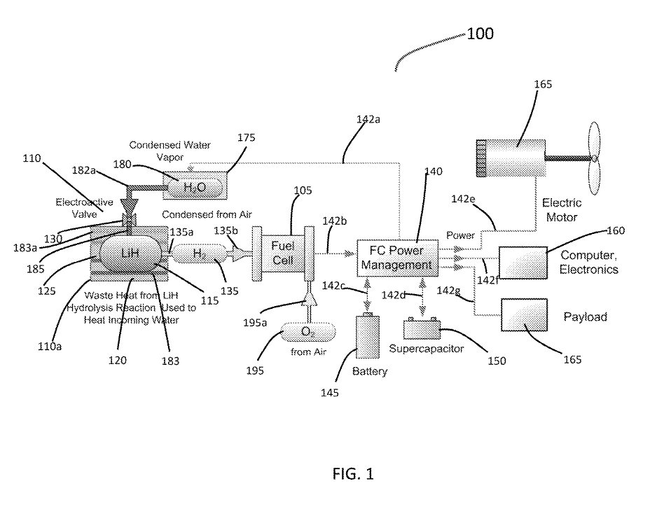

The embodiments of the invention shown in FIGS. 1-9 and described herein can use lithium hydride as a hydrogen source. In addition to serving as a convenient source of hydrogen, lithium hydride's hydrogen content also enables it to be used as a low-mass solution for radiation shielding. In addition to lithium hydride, various other metal hydrides can be used in the embodiments described, including hydrides of alkali-earth metal hydrides such as magnesium hydride, and transition metal hydrides, and complex metal hydrides, typically containing calcium, sodium, lithium, and aluminum or boron. (e.g., sodium borohydride, lithium aluminum hydride) and mixtures thereof.

Some embodiments of the invention include the systems 100, 200, 300, 400, 500, 600, 700, 800, 900 shown in FIGS. 1-9 respectively that can produce hydrogen from lithium hydride when mixed with water to produce hydrogen on demand. The system and methods can use water in any liquid or gaseous form, including liquid water, water vapor, steam, or mixtures thereof. Further, some embodiments can allow the water to be heated to a temperature between about 70° C. and about 290° C., which can allow the reaction process to be increased. In some embodiments, this can allow a reduction in the surface area required for the reaction by nearly 35 times as compared to using water at a temperature of about 25° C. In some embodiments, water obtained from air is passed into a lithium hydride reactor at a temperature between about 70° C. and about 290° C., where the reaction is the following:

LiH+H₂O→LiOH+H₂

where the hydrogen specific mass per kg reactant is 25.2% (not including the mass from water).

In addition to serving to increase the reaction kinetics, the process can consume substantially all of the water towards producing hydrogen instead of forming lithium hydride monohydrate. For example, if the reaction is allowed to occur below a temperature of about 70° C., lithium monohydrate buildup can occur by the following reaction:

LiOH+H₂O→LiOH.H₂O

In some embodiments, by reducing or substantially preventing the formation of lithium monohydrate, the formation of the waste product lithium hydroxide (i.e., LiOH) does not substantially increase the overall volume of the hydrogen source and by-product mixture, which can simplify reactor design. Further, if the system can maintain the temperature of the water below about 290° C., overall efficiency can improve. For example, if the temperature of the reaction proceeds at a temperature of about 300° C., then the following reaction can occur:

LiOH+LiH→Li₂O+H₂

While this reaction also releases hydrogen, the net hydrogen specific mass per kg reactant falls from about 25% to about 18%. Therefore, the embodiments of the invention including the control system and methods described and the systems 100, 200, 300, 400, 500, 600, 700, 800, 900 can enable the reaction of lithium hydride within a lithium hydride reactor using water that has been heated to a temperature between about 70° C. and to a maximum temperature of about 290° C. In this instance, the system can operate at an efficiency equating to a hydrogen specific mass than other systems that operate at lower or higher temperatures, and also avoids the following reaction that can further reduce operating efficiency:

2LiH→2Li+H₂

Some embodiments include a fuel cell power management system that can comprise a fuel cell stack, fuel, startup water, storage containers, tubing, electronics, battery, and one or more controllers such as a fuel cell power management module. One or more containers can be used to house the fuel, and tubing can be used to transfer the hydrogen fuel to the fuel cell stack. The electronics and controllers can include a fuel cell power management system that protects the fuel cell from electrical noise, operates the fuel cell at fixed operating voltage, and charges a rechargeable battery that is used to handling high and varying power demands. In some embodiments, the system produces hydrogen from lithium hydride by passively reusing waste water from the fuel cell and augmenting this by passively extracting water vapor from the air, which will be discussed in the following sections. In some of the embodiments described herein, waste heat from the reaction, a fuel cell with an electrical load of 5 W or more and ambient air and humidity can be sufficient to perpetuate the lithium hydride reaction while maintaining desired operating temperatures. In some embodiments, this approach avoids having to carry substantial quantities of water to produce hydrogen for high power applications, resulting in fuel energy density of about 4,850 Wh/kg, which is nearly 37 times higher than lithium ion batteries.

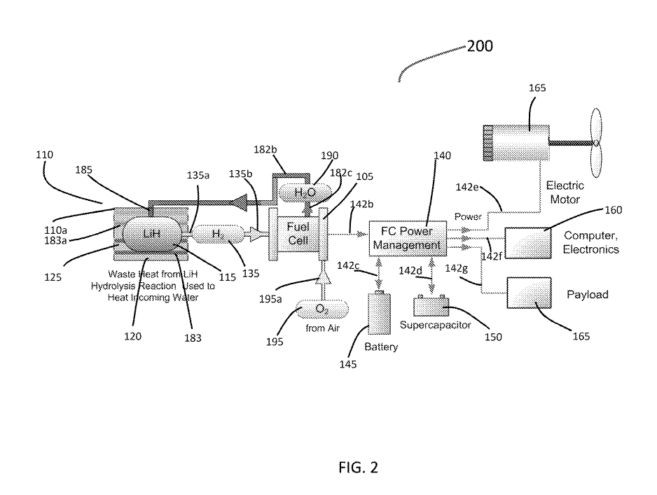

In some embodiments, water harvested from the surrounding environment can be used to produce hydrogen within the fuel cell system. Further, in some embodiments, harvested water can be subsequently heated (e.g., to a temperature between about 70° C. and about 290° C.) using one or more components of the system. For example, FIG. 1 illustrates one example embodiment of a schematic of a fuel cell system 100 comprising a lithium hydride hydrogen generation system including at least one water scavenging module 175. Variations of the system 100 that use the same components and/or additional and/or modified components are also described herein. For example, other alternative embodiments are shown as the systems 200, 300, 400, 500, 600, 700, 800, 900 illustrated in FIGS. 2-9 respectively, and will be described in more detail below.

Referring to FIG. 1, in some embodiments, the lithium hydride reactor 110 can comprise at least one containment vessel 115 including lithium hydride. In some embodiments, the containment vessel 115 can be at least partially enclosed and supported within an outer housing 120. In embodiments, the reaction vessel 115 and/or an outer housing 120 at least partially enclosing and supporting the reaction vessel 115 can include an outer thermal insulation layer 125 to insulate and trap heat from the lithium hydride reaction occurring within the vessel. In this instance, the lithium hydride reactor 110 can comprise an insulated lithium hydride reactor 110a (for example, as shown in FIGS. 1, 2, 3, 7-9).

In some embodiments of the invention, the system 100 can use water obtained or scavenged from outside the system 100 (e.g., from ambient air surrounding the system 100). In some embodiments, this scavenged water can be used as a co-reactant (i.e. with lithium hydride) in the vessel 115 to produce hydrogen. For example, in some embodiments, water can be scavenged using at least one water scavenging module 175 coupled to at least one lithium hydride reactor 110a. In some embodiments of the invention, water vapor from the air can be condensed and captured (shown as harvested water 180). In some embodiments, this capture can be facilitated using one or more small thermoelectric cooling devices (e.g., a solid state Peltier cooling device). For example, in some embodiments, the Peltier cooling device can be pulsed with a current to lower the temperature on the outer surface of the device. When the surface temperature drops below the temperature of dew point, water can condense onto the outer (cold side) surface of the Peltier cooling device from the surrounding environment.

In some embodiments, the water scavenging module 175 can be powered from at least one fuel cell 105, and controlled and monitored using at least one controller. For example, in the example embodiment illustrated in FIG. 1, the water scavenging module 175 can be electrically coupled to the fuel cell power management module 140 that can control the operation of the water scavenging module 175, and other operational parameters of the system 100. In this instance, the fuel cell power management module 140 can route power to the water scavenging module, which can also be routed to other components of the system. For example, in some embodiments, channel 142a can include at least one power line and/or communications channels. In some embodiments, power can be provided by the fuel cell 140 (e.g., through channel 142b), whereas in other embodiments, the fuel cell power management module 140 can route power from other sources, including for example a coupled battery 145, or other power source coupled to the system 100 such as a supercapacitor 150.

In some embodiments of the invention, the water scavenging module 175 can be monitored by the fuel cell power management module 140. For example, in some embodiments, the current draw of aforementioned thermoelectric cooling device can be monitored and controlled. Further, in some embodiments, the temperature of the thermoelectric cooling device can be monitored to ascertain device function and/or to monitor for device over-heating. For example, in some embodiments, the temperature of the thermoelectric cooling device can be monitored by monitoring the water condensation surface of the device, and/or by monitoring the opposite side of the thermoelectric stack, or an inner region of the thermoelectric stack. In some alternative embodiments of the invention, other condensing systems can be used. For example, in some embodiments, micro cryogenic coolers using miniature or micro-scale compressors can be used when the power efficiency load is acceptable. In some other embodiments, a fabric wicking system can be used to trap water vapor from the surrounding environment (for example using a hydroscopic fiber or coating).

Some embodiments of the invention can use various tubing, capillaries, micro-capillary, channels, cavities, micro-channels and micro-cavities to contain, trap, and transfer water from the water scavenging module 175. In some further embodiments, the water scavenging module 175 and any coupled portion of the system 100 (and/or systems 200, 300, 400, 500, 600, 700, 800, 900) can also include one or more filters, one or more control valves, one or more membranes, and one or more sensors. For example, referring to FIGS. 1, 3, 4, 6, 8-9 in some embodiments, depending on the size of the system, the water scavenging module 175 can be fluidly coupled to the lithium hydride reactor 110a using one or more conduits that can serve to transport harvested water from the water scavenging module 175 to the reactor 110 (either 110a or 110b as shown). In most instances, the flow of water will be laminar, and in some embodiments, can be assisted by surface tension effects including for example capillary action. Further, in some embodiments of the invention, one or more valves can be used to permit transport of water vapor into the lithium hydride vessel 115 due to lower partial pressure of water vapor above the hydride bed compared to the outside. Some embodiments of the invention can deploy one or more mechanical or electro-mechanical valves to control of the flow of fluid within the system. For example, in some embodiments, one or more mechanical or electro-mechanical valves can control flow of fluid (e.g., water, water vapor or steam) before it enters the lithium hydride reactor 115. As described earlier, in some embodiments of the invention, water and/or water steam can react with lithium hydride to produce hydrogen gas (feeding hydrogen source 135) and lithium hydroxide solid, with substantially no other byproducts such as lithium hydroxide monohydrate.

Referring to at least FIG. 1, in some embodiments, the system 100 can use bypass tubing or conduit with an optional electro-active valve 130 in place to ensure the water reaching the lithium hydride reactor 110a is within the desired temperature (about 70° C. to about 120° C.). For example, in some embodiments, water emerging from the water scavenging module 175 through conduit 182a can be halted, diverted, and/or cooled or heated prior to being delivered to the reactor 110a as water and/or steam 185. For example, in some embodiments, if the temperature of the water and/or water steam 185 is too high, cooler water can be supplied and mixed with the water and/or water steam 185 to lower the temperature prior to entering the lithium hydride reactor 110a.

In some embodiments, one or more of the internal surfaces of the one or more conduits described herein (e.g., conduit 182a and/or any of the conduits 182b, 182c, 182d, 182e, 182f, 182g shown in the one or more of the systems 200, 300, 400, 500, 600, 700, 800, 900 illustrated in FIGS. 2-9 respectively) can be coated or otherwise surface treated to lower the surface energy. In some embodiments, one or more of the internal surfaces of the one or more of the aforementioned conduits can be made more hydrophilic to encourage wetting of the surface and movement of fluid into one or more channels or cavities. For example, in some embodiments, the internal surfaces can be functionalized with hydroxyl groups using chemical and/or polymer coatings. In some other embodiments, one or more of the internal surfaces of the can be made more hydrophobic to alter or substantially prevent flow to a region of the system. In this instance, one or more hydrophobic regions of one or more of the internal surfaces can act as a valve.

In some embodiments of the invention, harvested water 180 can be pre-heated prior to entering the lithium hydride reactor and reaction with the lithium hydride. In some embodiments, the harvested water 180 can be heated immediately after emerging from the water scavenging module 175 and/or just prior to entering the reactor 110a. Further, in some embodiments, heat from the reaction vessel 115 can be captured and used to pre-heat the harvested water 180 assisted by the insulation layer 125. For example, the insulation layer 125 can comprise a layer of glass, ceramic and/or aerogel, or combinations thereof that can be placed at least partially around the reaction vessel 115. Further, in some embodiments of the invention, the outer housing 120 at least partially enclosing the vessel 115 can include at least one insulation layer 125 comprising one or more layers of glass, ceramic and/or aerogel. Examples of insulating materials useful for at least one embodiment of the invention include glass, ceramic and/or aerogel include silicate, alumosilicate, alumina, borosilicate-based glasses and ceramics and mixtures thereof. Depending on the size of the system, in some embodiments, the insulation layer 125 can comprise a thickness of about 1 millimeter or less. In some other embodiments, the insulation layer 125 can comprise a thickness of about 1-10 millimeters. In some further embodiments, the insulation layer 125 can comprise a thickness of greater than about 10 millimeters.

In some embodiments of the invention, one or more conduits or tubes carrying harvested water 180 can be coupled to the insulation layer 125 or coating to form a heat exchanger 183. For example, in some embodiments, the one or more conduits or tubes 183a can be coupled to the outer surface of the reaction vessel insulation layer 125. In some further embodiments, at least a portion of one or more of the conduits or tubes 183a can be embedded in one more insulation regions. For example, in some embodiments, one or more conduits or tubes 183a can be at least partially embedded in the outer surface of the reaction vessel insulation layer 125 and/or embedded in an outer insulation layer placed between the vessel 115 and an outer housing 120. In at least some embodiments of the invention, at least a portion of the one or more conduits or tubes 183a can be thermally conductive tubing acting as heat exchanger and facilitating transfer of heat from the reactor vessel 115 to the harvested water 180.

In some embodiments of the invention, the addition of water (such as harvested water 180) to the vessel 115 can create hydrogen (e.g., by the reaction mechanisms described earlier). In some embodiments, the hydrogen can be passed (e.g., through a conduit 135a) to a hydrogen fuel source 135. In some embodiments, the hydrogen can be fed from the hydrogen fuel source 135 (e.g., using a conduit 135b) to a fuel cell 105. In some other embodiments, the hydrogen can pass directly from the vessel 115 to the fuel cell 105. For example, in some embodiments, a direct hydrogen feed to the reactor can be represented by the conduit 135a, hydrogen fuel source 135 and conduit 135b.

In some embodiments, water vapor can be readily available as waste from the fuel cell 105. Further, in some embodiments, water can be captured from the fuel cell 105 for delivery to the vessel 115. For example, in some embodiments, water capture from a fuel cell 105 can be facilitated using an air permeable vapor barrier around the cathode, where water vapor is produced at 100% relative humidity. In some embodiments, a water management controller can facilitate transfer of water from the fuel cell exhaust. This can be collected in a reservoir and/or passed directly to the lithium hydride reactor. In some embodiments, the water management controller can be included in the fuel cell management system 140. For example, FIG. 2 is a schematic of a fuel cell system 200 comprising a lithium hydride hydrogen generation system including a fuel cell water delivery system according to one embodiment of the invention. In some embodiments of the invention, water can be harvested from the fuel cell 105 (shown as water 190 fed by conduit 182c). Further, the water 190 can be pre-heated prior to entering the lithium hydride reactor 110a. Using the system 200, waste heat from the fuel cell 105 can be used to heat water 190. For example, to ensure water reaching the lithium hydride vessel 115 from the fuel cell 105 is within the desired temperature of 70° C. to 120° C., the water can be halted, diverted, and/or cooled or heated prior to entering the reactor 110a. In some embodiments of the invention, water harvested from the fuel cell (water 190 fed by conduit 182c) can be pre-heated prior to entering the lithium hydride reactor 110a. In some embodiments, this can be achieved using a system of conduits and thermally insulated portions of the reaction vessel and/or outer housing as described earlier with respect to the system 100 illustrated in FIG. 1. Further, as also shown in FIG. 1, in some embodiments, waste heat from lithium hydrolysis within the vessel 115 can be used to heat the incoming water (from any source).

In some embodiments, during delivery of water 190 from the fuel cell 105 to the reactor 110a, the fuel cell management system 140 can monitor a hydrogen supply pressure (from hydrogen fuel source 135) to the fuel cell 105 using one or more pressure sensor monitors. In some embodiments, a controller within the fuel cell management system 140 can maintain the hydrogen pressure at a target set point by dispensing water to the hydride (e.g., using a butterfly valve, a pump, or a membrane or a combination thereof). Further, in some embodiments, a feedback control system within the fuel cell management system 140 can be used for controlling lithium hydride release to maintain a target pressure of hydrogen supplied to the fuel cell 105 from the hydrogen source 135. Further, in some embodiments, the fuel cell management system 140 can control delivery of oxygen to the fuel cell. For example, in some embodiments, oxygen from an oxygen source 195 can be fed to the fuel cell 105 (e.g., using a conduit 195a) under control of the fuel cell management system 140.

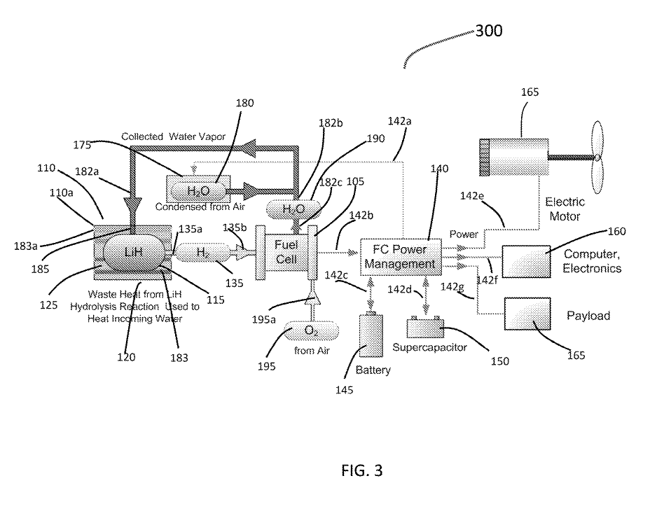

Some embodiments can utilize more than one water harvest and delivery system. As depicted in the FIG. 3 illustrating a schematic of a fuel cell system 300, in some embodiments, the fuel cell system 300 can comprise a lithium hydride hydrogen generation system including a fuel cell water delivery system (water 190) in addition to a water scavenging module 175 (showing harvested water 180). For example, in some embodiments of the invention, the fuel cell system 300 can comprise the water scavenging module 175 as described in the fuel cell system 100 illustrated in FIG. 1, and also the fuel cell water delivery system of the fuel cell system 200 illustrated in FIG. 2. Further, as illustrated, in some embodiments, harvested water 180 emerging from the water scavenging module 175 can fluidly couple to water steam emerging from the fuel cell (water 190 from conduit 182c). In these embodiments, the waste heat from the fuel cell 105 can be used to heat the water, and in some embodiments, to ensure water reaching the lithium hydride vessel 115 from the fuel cell 105 is within the desired temperature of about 70° C. to about 120° C., the water can be halted, diverted, and/or cooled or heated prior to entering the reactor 110a. Further, in some embodiments of the invention, water harvested from the fuel cell (water 190) can be pre-heated prior to entering the lithium hydride reactor 110a using a system of conduits and thermally insulated portions of the reaction vessel and/or outer housing as described earlier with respect to the system 100 illustrated in FIG. 1. In this instance, waste heat from lithium hydrolysis within the vessel 115 can be used to heat the incoming water.

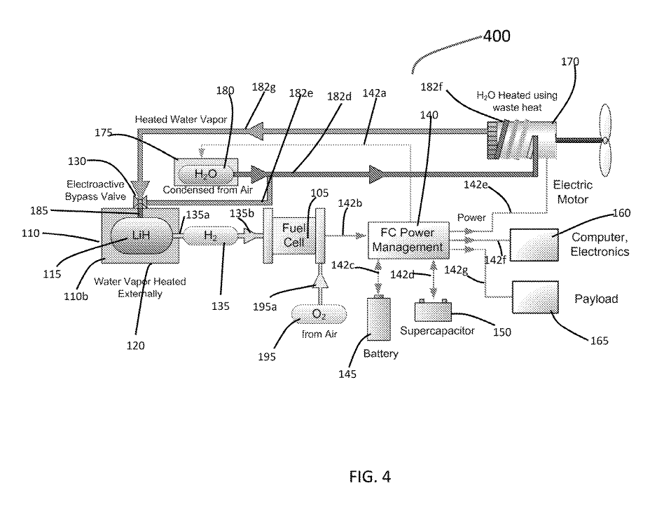

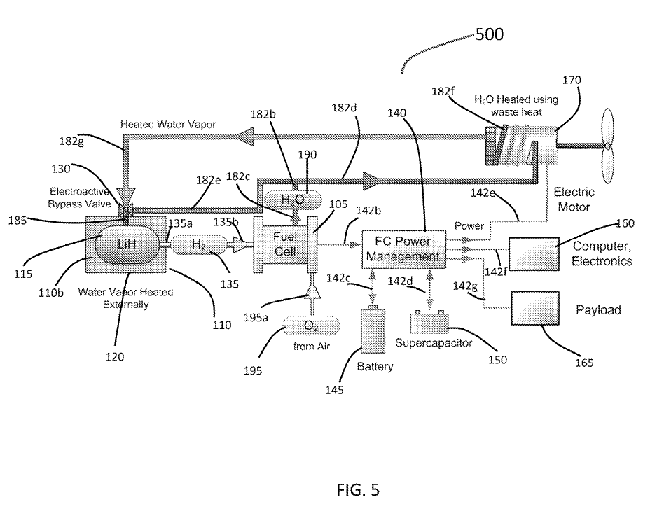

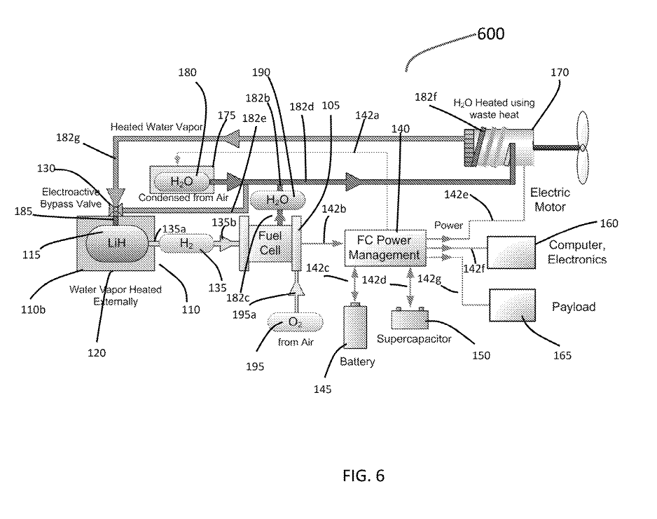

In some further embodiments, waste heat from coupled peripheral devices and/or from systems being powered by the fuel cell system can be used to heat fluid entering the lithium hydride reaction. For example, FIG. 4 is a schematic of a fuel cell system 400 comprising a lithium hydride hydrogen generation system including a water scavenging module 175 and a waste heat capture system. In some embodiments, the system 400 can comprise a waste heat capture system comprising an electric motor with a coupled heater exchanged (shown as electric motor 170 including conduit 1820. FIG. 5 is a schematic of a fuel cell system 500 comprising a lithium hydride hydrogen generation system including a fuel cell water delivery system and a waste heat capture system comprising an electric motor 170 including the conduit 182f. Further, FIG. 6 is a schematic of a fuel cell system 600 comprising a lithium hydride hydrogen generation system including a fuel cell water delivery system, a waste heat capture system comprising electric motor 170 including conduit 182f, and a water scavenging module 175 according to one embodiment of the invention. As shown, the systems 400, 500, 600 can utilize heat generated by an electric motor 170 that is powered by the fuel cell 105 using the conduit 182f at least partially coupled or proximate the motor 170 to scavenge heat generated by the electric motor 170 during operation. In some embodiments, the electric motor 170 can be the only source of heat that can be used to control the water entering the vessel to a temperature range of about 70° C. to about 120° C.

As shown in FIG. 4, the system 400 can include a water scavenging module 175 as described earlier that can transfer at least some harvested water 180 to the waste heat capture system comprising electric motor 170 by passing harvested water 180 through a conduit 182d to the conduit 182f that at least partially encloses the electric motor 170. Further, the water scavenging module 175 can also be configured to divert at least some water to the bypass valve 130 (e.g., shown as conduit 182e). In this instance, the system 400 can include a lithium hydride reactor 110 that is uninsulated (shown as reactor 110b), and the waste heat from the reactor 110b is not captured. Further, the bypass valve 130 and/or the fuel cell management system 140 can control the temperature of the water entering the reactor 115 using controlled proportions of heated water from the heat exchanger (electronic motor 170 and conduit 182f), and with cooler (unheated) water emerging directly from the water scavenging module 175 via conduit 182e.

Similarly, in some other embodiments, the system 500 can be configured to proportion at least some water from the fuel cell 105 to enter the heat exchanger (electric motor 170 and conduit 182f) while further providing an option to divert at least some water 190 emerging from the fuel cell 105 to the bypass valve 130. Again, in this instance, the system 500 can use a reactor 110b where the waste heat from the reactor is not captured, and the bypass valve 130 and/or the fuel cell management system 140 can control the temperature of the water entering the reactor using controlled proportions of heated water from the heat exchanger (from conduit 182g), and with water 190 emerging directly from the fuel cell 105 (shown as water 190 feeding to conduit 182b and conduit 182d). Further, in some embodiments of the systems 400, 500, the bypass valve 130 can also divert water to be re-circulated through the heat exchanger (i.e., through conduit 182f coupled to the electronic motor 170) by feeding water through conduit 182e, 182d, and into conduit 182f. In some embodiments, this process can continue until the water reaches a specific temperature controlled by the bypass valve 130 and/or a controller in the fuel cell management system 140.

Referring to FIG. 6, in some further embodiments, the system 600 can include a fuel cell water delivery system (water 190 from fuel cell 105) and a water scavenging module 175 coupled to a waste heat capture system (e.g., the heat exchanger comprising the electric motor 170 and conduit 182f). In this instance, the water scavenging module 175 can also be configured to divert at least some water 180 to the bypass valve 130, and the waste heat from the reactor 110b is not captured. In some embodiments of the invention, the bypass valve 130 and/or the fuel cell management system 140 can control the temperature of the water entering the reactor 115 using controlled proportions of heated water from the heat exchanger (e.g., water fed from conduit 182f into conduit 182g), and with cooler water emerging directly from the water scavenging module (through conduit 182e). Further, at least some water 190 from the fuel cell can also enter the heat exchanger (shown as conduit 182b coupled to conduit 182d, 182f). In some embodiments, the bypass valve 130 and/or the fuel cell management system 140 can control the temperature of the water entering the reactor 115 using controlled proportions of heated water from the heat exchanger (conduit 182g), and with water emerging directly from the water scavenging module (conduit 182e). Further, in some other embodiments of the system 600, the bypass valve 130 can divert water to be recirculated through the heat exchanger (e.g., through the conduits 182e, 182d, 182f).

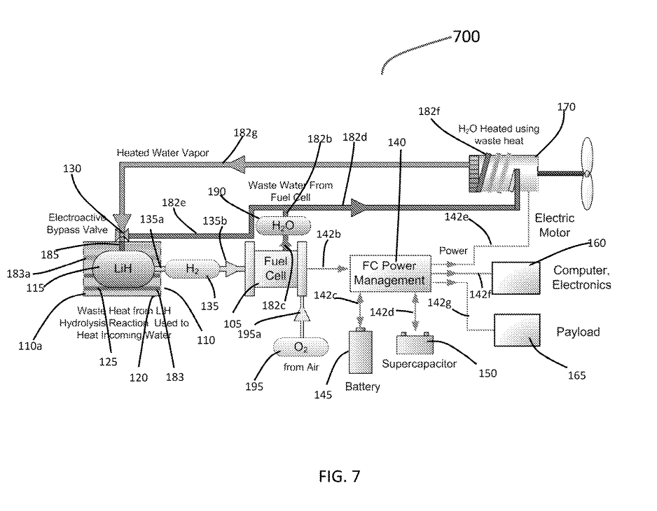

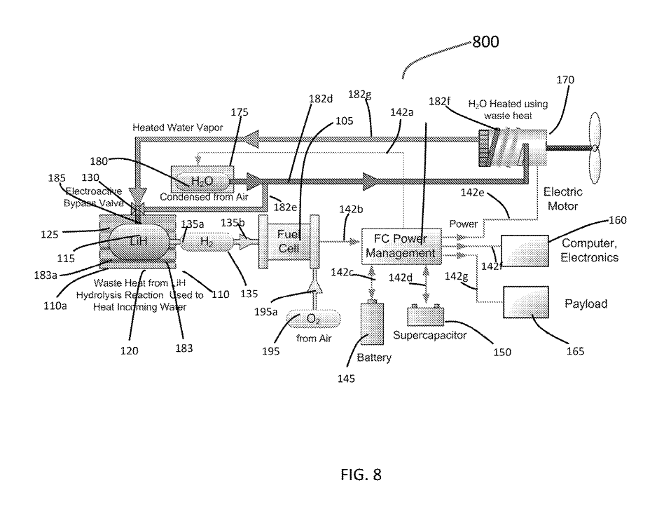

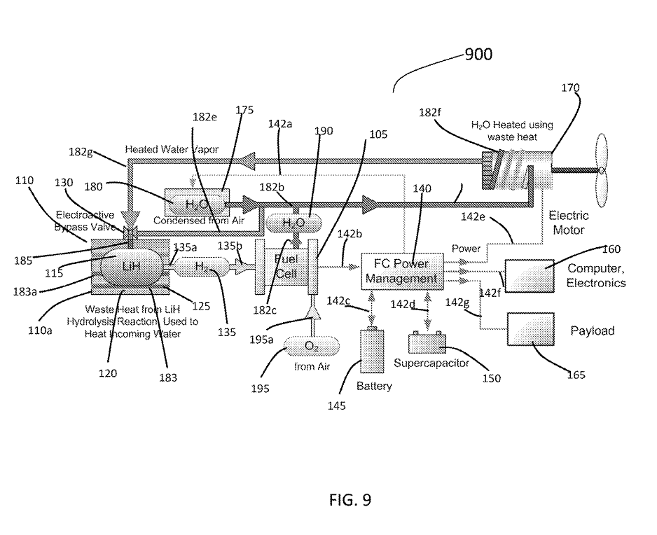

Some embodiments of the invention can use waste heat from coupled peripheral devices and/or from systems being powered by the fuel cell system combined with heat released from the reactor during hydrogen fuel production. For example, FIG. 7 is a schematic of a fuel cell system 700 comprising a lithium hydride hydrogen generation system including a fuel cell water delivery system and a waste heat capture system (e.g., the heat exchanger comprising the electric motor 170 and conduit 182f), and FIG. 8 is a schematic of a fuel cell system 800 comprising a lithium hydride hydrogen generation system including a water scavenging module 175 and a waste heat capture system (e.g., the heat exchanger comprising the electric motor 170 and conduit 182f). Further, FIG. 9 is a schematic of a fuel cell system 900 comprising a lithium hydride hydrogen generation system including a fuel cell water delivery system, a waste heat capture system (e.g., the heat exchanger comprising the electric motor 170 and conduit 182f), and a water scavenging module 175 according to another embodiment of the invention.

In some embodiments, the system 700 can operate similarly to that described earlier with respect to the system 500 illustrated in FIG. 5, except the reactor 110 can comprise an insulated reactor 110a. Further, in some embodiments, the system 800 can operate similarly to that described earlier with respect to the system 400 illustrated in FIG. 4, except the reactor 110 can comprise an insulated reactor 110a. Further, the system 900 can operate similarly to that described earlier with respect to the system 600 illustrated in FIG. 6, except the reactor 110 comprises an insulated reactor 110a. Within the systems 700, 800, and 900, waste heat captured from the lithium hydride hydrogen generation system can be used to heat the water entering the reactor 110a in addition to heat obtained from the waste heat capture system (e.g., the heat exchanger comprising the electric motor 170 and conduit 182f), the fuel cell (from water 190), or both. Moreover, the systems 700, 800, and 900 can include additional fluid control and monitoring systems to monitor heat capture from up to three systems including the fuel cell 140, the reactor 110a, and the external heat exchanger (electric motor 170 including conduit 182f).

In some embodiments, any one of the controlling or monitoring functions and/or any one sensor or valve of the fuel cell system including a lithium hydride hydrogen generation system can be remotely controlled and/or monitored. For example, in addition to the above-mentioned embodiments, any one of the systems 100, 200, 300, 400, 500, 600, 700, 800, 900 shown in FIGS. 1-9 can include a wireless and/or an optically coupled interface. For example, in some embodiments, some functions of the lithium hydride hydrogen generation system may comprise one or more wireless and/or optical couplings and interfaces to one or more components of the system. In some embodiments, this can include the electro-active valve 130, or one or more temperature and pressure sensors within the lithium hydride reactor 110a, 110b and/or water scavenging system 175. In some instances for example, the fuel cell power management module 140 can receive a signal representing at least one operational parameter of the lithium hydride hydrogen generation system. Further, in some embodiments, the fuel cell power management module can control at least one operational parameter of the lithium hydride hydrogen generation system wirelessly and/or optically. For example, in some embodiments, the battery 145 can be linked to the fuel cell management system 140 using a channel 142c. In some embodiments, the supercapacitor 150 can be linked to the fuel cell management system 140 using a channel 142d. Further, in some embodiments, power can be routed from the fuel cell 105 to the electronic motor 160, 170 using a channel 142e. In some further embodiments, power can be routed from the fuel cell 105 to a computer and/or electronics 160 using a channel 142f. In some other embodiments, power can be routed from the fuel cell 105 to a payload 165 using a channel 142g. In some further embodiments, the fuel cell can also be wirelessly and/or optically controlled. In other embodiments, other devices including coupled power storage devices, and at any device at least partially drawing power from the system can be wireless and/or optically controlled.

Some embodiments of the invention can also include various computer-implemented methods for controlling at least one operation of the fuel cell system including a lithium hydride hydrogen generation system. Further, some embodiments of the invention can also relate to a device or an apparatus for performing computer-implemented methods for controlling at least one operation of the fuel cell system including a lithium hydride hydrogen generation system. In some embodiments, the apparatus can comprise the computers and electronics and/or the fuel cell power management devices depicted in the schematics shown in FIGS. 1-9. These systems can include at least one computing device, including at least one or more processors, which in some embodiments, can be coupled to at least one computer server. Further, in some embodiments, any one of the systems 100, 200, 300, 400, 500, 600, 700, 800, 900 shown in FIGS. 1-9 can include a system comprising a network interface and an application interface coupled to at least one processor capable of running at least one operating system. The system can also include at least one software module capable of controlling at least one function and/or monitoring at least one parameter of any one portion of the fuel cell system including a lithium hydride hydrogen generation system. For example, this can include controlling at least one function and/or monitoring at least one parameter of any one portion of the at least the lithium hydride reactor, the electro-active bypass valve, the water scavenging system, and one or more components of the fuel cell including at least one sensor. Further, in some embodiments, coupled power storage devices, and at any device at least partially drawing power from the system can be at least partially controlled using the one or more software modules comprising at least one computer-implemented method.

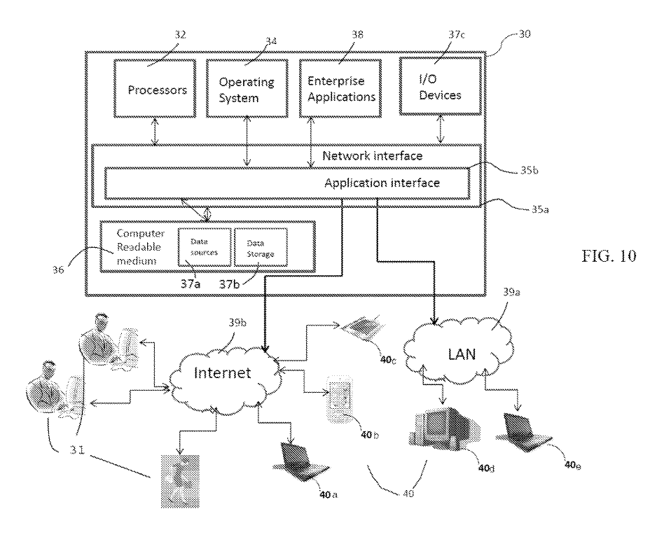

FIG. 10 illustrates a computer system 30 configured for operating and processing components and methods of operation of any one of the systems 100, 200, 300, 400, 500, 600, 700, 800, 900 shown in FIGS. 1-9. Further, the computer system 30 can also manage the organization of data and data flow between various components of the systems 100, 200, 300, 400, 500, 600, 700, 800, 900 including controlling one or more functions of the fuel cell management system 140. As shown, the system 30 can include at least one computing device, including at least one or more processors 32. Some processors 32 can include processors 32 residing in one or more conventional server platforms. The system 30 can include a network interface 35a and an application interface 35b coupled to at least one processors 32 capable of running at least one operating system 34. Further, the system 30 can include a network interface 35a and an application interface 35b coupled to at least one processors 32 capable of running one or more of the software modules (e.g., enterprise applications 38).

Some embodiments include the system 30 comprising at least one computer readable medium 36 coupled to at least one data storage device 37b, and/or at least one data source 37a, and/or at least one input/output device 37c. In some embodiments, the invention embodied by the lease purchase system can also be embodied as computer readable code on a computer readable medium 36. The computer readable medium 36 can be any data storage device that can store data, which can thereafter be read by a computer system (such as the system 30). Examples of the computer readable medium 36 can include hard drives, network attached storage (NAS), read-only memory, random-access memory, FLASH based memory, CD-ROMs, CD-Rs, CD-RWs, DVDs, magnetic tapes, other optical and non-optical data storage devices, or any other physical or material medium which can be used to tangibly store the desired information or data or instructions and which can be accessed by a computer or processor (including processors 32).

With the above embodiments in mind, it should be understood that the invention can employ various computer-implemented operations involving data generated by any of the systems 100, 200, 300, 400, 500, 600, 700, 800, 900 stored in the computer system 30. Moreover, the above-described databases and applications can store analytical models and other data on computer-readable storage media 36 within the system 30 and on other computer-readable storage media coupled to the system 30. These operations are those requiring physical manipulation of physical quantities. Usually, though not necessarily, these quantities take the form of electrical, electromagnetic, or magnetic signals, optical or magneto-optical form capable of being stored, transferred, combined, compared and otherwise manipulated.

In some embodiments of the invention, the computer readable medium 36 can also be distributed over a conventional computer network via the network interface 35a so that the computer-implemented methods embodied by the computer readable code can be stored and executed in a distributed fashion. For example, in some embodiments, one or more components of the system 30 can be tethered to send and/or receive data through a local area network (“LAN”) 39a. In some further embodiments, one or more components of the system 30 can be tethered to send or receive data through an internet 39b (e.g., a wireless internet). In some embodiments, at least one software application 38 running on one or more processors 32 can be configured to be coupled for communication over a network 39a, 39b. In some embodiments, one or more components of the network 39a, 39b can include one or more resources for data storage, including any other form of computer readable media beyond the media 36 for storing information and including any form of computer readable media for communicating information from one electronic device to another electronic device.

In some embodiments, the network 39a, 39b can include wide area networks (“WAN”), direct connections (e.g., through a universal serial bus port) or other forms of computer-readable media 36, or any combination thereof. Further, in some embodiments, one or more components of the network 39a, 39b can include a number of client devices which can be personal computers 40 including for example desktop computers 40d, laptop computers 40a, 40e, digital assistants and/or personal digital assistants (shown as 40c), cellular phones or mobile phones or smart phones (shown as 40b), pagers, digital tablets, internet appliances, and other processor-based devices. In general, a client device can be any type of external or internal devices such as a mouse, a CD-ROM, DVD, a keyboard, a display, or other input or output devices 37c. In some embodiments, various other forms of computer-readable media 36 can transmit or carry instructions to a computer 40, including a router, private or public network, or other transmission device or channel, both wired and wireless. The software modules 38 can be configured to send and receive data from a database (e.g., from a computer readable medium 36 including data sources 37a and data storage 37b that can comprise a database), and data can be received by the software modules 38 from at least one other source. In some embodiments, at least one of the software modules 38 can be configured within the system to output data to at least one user 31 via at least one digital display (e.g., to a computer 40 comprising a digital display).

In some embodiments, the system 30 can enable one or more users 31 to receive, analyze, input, modify, create and send data to and from the system 30, including to and from one or more enterprise applications 38 running on the system 30. Some embodiments include at least one user 31 coupled to a computer 40 accessing one or more modules of the computer implemented method including at least one enterprise applications 38 via a stationary I/O device 37c through a LAN 39a. In some other embodiments, the system 30 can enable at least one user 31 (through computer 40) accessing enterprise applications 38 via a stationary or mobile I/O device 37c through an internet 39a.

Any of the operations described herein that form part of the invention are useful machine operations. The invention also relates to a device or an apparatus for performing these operations. The apparatus can be specially constructed for the required purpose, such as a special purpose computer. When defined as a special purpose computer, the computer can also perform other processing, program execution or routines that are not part of the special purpose, while still being capable of operating for the special purpose. Alternatively, the operations can be processed by a general purpose computer selectively activated or configured by one or more computer programs stored in the computer memory, cache, or obtained over a network. When data is obtained over a network the data can be processed by other computers on the network, e.g. a cloud of computing resources.

The embodiments of the present invention can also be defined as a machine that transforms data from one state to another state. The data can represent an article, that can be represented as an electronic signal and electronically manipulate data. The transformed data can, in some cases, be visually depicted on a display, representing the physical object that results from the transformation of data. The transformed data can be saved to storage generally or in particular formats that enable the construction or depiction of a physical and tangible object. In some embodiments, the manipulation can be performed by a processor. In such an example, the processor thus transforms the data from one thing to another. Still further, the methods can be processed by one or more machines or processors that can be connected over a network. Each machine can transform data from one state or thing to another, and can also process data, save data to storage, transmit data over a network, display the result, or communicate the result to another machine. Computer-readable storage media, as used herein, refers to physical or tangible storage (as opposed to signals) and includes without limitation volatile and non-volatile, removable and non-removable storage media implemented in any method or technology for the tangible storage of information such as computer-readable instructions, data structures, program modules or other data.

Although method operations can be described in a specific order, it should be understood that other housekeeping operations can be performed in between operations, or operations can be adjusted so that they occur at slightly different times, or can be distributed in a system which allows the occurrence of the processing operations at various intervals associated with the processing, as long as the processing of the overlay operations are performed in the desired way.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

1. A fuel cell system comprising:
a fuel cell coupled to at least one controller, the at least one controller configured to route power generated by the fuel cell to at least one peripheral device;
a hydrogen generator comprising a reactor vessel at least partially enclosed by a reactor housing, the hydrogen generator fluidly coupled to the fuel cell and configured to deliver hydrogen to the fuel cell; and
at least one water harvesting system coupled to the at least one controller, the at least one water harvesting system fluidly coupled to the hydrogen generator and configured to deliver water or water vapor to the hydrogen generator.

2. The system of claim 1, wherein the hydrogen generator comprises a lithium hydride reactor.

3. The system of claim 1, further comprising at least one auxiliary power source coupled to the at least one controller.

4. The system of claim 1, wherein the at least one water harvesting system comprises a water scavenging module configured to extract water from ambient air.

5. The system of claim 1, wherein the at least one water harvesting system comprises fuel cell emitted water captured from the fuel cell.

6. The system of claim 2, wherein the hydrogen generator includes insulation positioned at least partially between the reactor housing and reactor vessel.

7. The system of claim 1, further comprising at least one waste heat recovery system.

8. The system of claim 7, wherein the waste heat recovery system comprises at least one insulated conduit within the hydrogen generator.

9. The system of claim 7, wherein the waste heat recovery system comprises at least one conduit coupled to the at least one peripheral device.

10. The system of claim 1, further comprising at least one control valve configured to control a flow of the water or water vapor to the hydrogen generator.

11. The system of claim 10, wherein the at least one control valve comprises an electroactive bypass valve.

12. The system of claim 10, wherein the at least one control valve is configured and arranged to control flow of the water or water vapor from the fuel cell.

13. The system of claim 1, wherein the at least one controller is configured and arranged to control delivery of the water or water vapor to the reactor vessel to maintain a lithium hydrolysis reaction temperature of between about 70° C. and about 120° C.

14. A fuel cell system comprising:
a fuel cell coupled to at least one controller, the at least one controller configured to route power generated by the fuel cell to at least one peripheral device;
a hydrogen generator comprising a reactor vessel at least partially enclosed by a reactor housing, the hydrogen generator including a first waste heat recovery system comprising at least one insulated conduit within the hydrogen generator;
a plurality of water capturing systems coupled to the at least one controller, the plurality of water capturing systems including at least one water scavenging module configured to extract water from ambient air and at least one water harvesting system comprising fuel cell emitted water captured from the fuel cell; and
wherein the plurality of water capturing systems are fluidly coupled to the hydrogen generator and configured to deliver captured water or water vapor to the hydrogen generator.

15. The system of claim 14, further including a second waste heat recovery system comprising at least one conduit coupled to the at least one peripheral device.

16. A fuel cell system fueling method comprising:
providing a fuel cell coupled to at least one controller, the at least one controller configured to route power generated by the fuel cell to at least one peripheral device;
fluidly coupling a hydrogen generator to the fuel cell, the hydrogen generator comprising a reactor vessel at least partially enclosed by a reactor housing;
fluidly coupling at least one water capturing system to the hydrogen generator;
producing a source of hydrogen by operating the at least one water capturing system to deliver water or water vapor to the hydrogen generator; and
routing the hydrogen to the fuel cell to produce power, the power optionally used to power the at least one peripheral device.

17. The method of claim 16, wherein the hydrogen generator includes a first waste heat recovery system comprising at least one insulated conduit within the hydrogen generator;

18. The method of claim 16, wherein the at least one water capturing system includes at least one of a water scavenging module configured to extract water from ambient air and at least one water harvesting system comprising fuel cell emitted water captured from the fuel cell.

19. A computer-implemented control method for operating a fuel cell system comprising:
a non-transitory computer-readable medium in data communication with at least one processor, the non-transitory computer-readable medium including software instructions comprising a fuel cell control system and method;
one or more processors configured to execute the software instructions to:
instruct at least one controller to operate a fuel cell coupled to at least one controller;
operate at least one water capturing system to deliver water or water vapor to a hydrogen generator fluidly coupled to the fuel cell; and
control delivery of hydrogen from the hydrogen generator to the fuel cell to produce power, the power optionally used to power at least one peripheral device.

20. The computer-implemented control method of claim 19, wherein the at least one controller controls delivery of the water or water vapor to the reactor vessel to maintain a lithium hydrolysis reaction temperature of between about 70° C. and about 120° C.
